(19) United States
(12) Patent Application Publication
(10) Pub. No.: US 2008/0261097 A1
(43) Pub. Date: Oct. 23, 2008

(54) MEMBRANE-ELECTRODE ASSEMBLY AND DIRECT METHANOL FUEL CELL

(75) Inventors: Osamu Kubota, Hitachi (JP); Hiroshi Yamauchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Ltd.

(21) Appl. No.: 12/105,606

(22) Filed: Apr. 18, 2008

(30) Foreign Application Priority Data
Apr. 19, 2007 (JP) 2007-109976

(51) Int. Cl. H01M 8/10

(52) U.S. Cl. 429/30

(57) ABSTRACT

Disclosed is a membrane-electrode assembly including an anode, a cathode, and a proton-conductive polymer electrolyte membrane and further including a diffusion enhancing layer disposed between the cathode and the proton-conductive polymer electrolyte membrane. The membrane-electrode assembly and a direct methanol fuel cell using the same work to effectively eliminate product water and electrolyte membrane-permeated water remaining in the vicinity of the interface between the cathode and the electrolyte membrane to feed a reaction gas sufficiently to the vicinity of the interface between the cathode and the electrolyte membrane, and exhibit high performance stably over a long period of time.

### CLAIM OF PRIORITY

The present application claims priority from Japanese application serial No. 2007-109976 filed on Apr. 19, 2007, the content of which is hereby incorporated by reference into this application.

### BACKGROUND OF THE INVENTION

1. Field of the Invention

The present invention relates to a membrane-electrode assembly and a direct methanol fuel cell which discharge water satisfactorily.

2. Description of the Related Art

Fuel cells electrochemically directly extract electric energy from a fuel and thereby have a high energy efficiency. In addition, they discharge mainly water and are friendly to the environment. They are therefore applied typically to automobiles, dispersed power sources, and electronic information devices. Among these uses, the fuel cells have received attention particularly in electronic information devices as power sources that will operate over a long period and serve as alternates for lithium cells, and there have been proposed various electronic information devices provided with fuel cells.

Japanese Unexamined Patent Application Publication (JP-A) No. H09-213359 discloses an electronic information device provided with a fuel cell using a hydrogen absorbing cylinder including a hydrogen absorbing alloy. JP-A No. 2002-49440 discloses an electronic information device provided with a fuel cell using methanol as a fuel.

A direct methanol fuel cell (hereinafter abbreviated as DMFC) of a system where liquid methanol is directly oxidized to extract electricity does not require an extra device such as a reformer, and thereby has a simple configuration as a cell system.

The principle of power generation in DMFC is represented by following Formulae (1) to (3):

Reaction in anode: CH₃OH+H₂O→6H⁺+6e⁻+CO₂ (1)

Reaction in cathode: 6H⁺+6e⁻+1.50₂→3H₂O (2)

Total reaction: CH₃OH+1.50₂→2H₂O+CO₂ (3)

In the reactions, hydrogen ions (protons) diffuse in a proton-conductive polymer electrolyte membrane (hereinafter briefly referred to as electrolyte membrane) from the anode side toward the cathode side. When a fuel cell is operated at temperatures near to about 100° C., i.e., near to the boiling point of water, water contained in the electrolyte membrane evaporates more and escapes from the electrolyte membrane. This renders the electrolyte membrane dry and less proton-conductive. As a possible solution to this, a gas to be fed to the cell is moistened to prevent the electrolyte membrane from drying. This known technique has been widely employed. According to this technique, however, the electrodes and electrolyte membrane are moistened (wetted), whereby water accumulates or remain in the electrodes to clog pores, and this prevents oxygen gas from diffusing toward the cathode.

On the other hand, water is produced according to the reaction of Formula (2) in the cathode in DMFC. Such water produced as a result of cell reaction is hereinafter referred to as “cathode product water.” In addition, a certain amount of water accompanies the protons diffusing in the electrolyte membrane and is discharged from the electrolyte membrane toward the cathode. Furthermore, some water permeates the electrolyte membrane and is discharged from the electrolyte membrane toward the cathode. The water accompanying the protons and water permeating the electrolyte membrane are hereinafter referred to as “electrolyte membrane-permeated water.”

Water is generated in vapor form upon formation as a result of cell reaction, but some of the water vapor condenses into condensed water in the cathode under some conditions including the structure and material of the cathode and operation conditions. Some of the condensed water is discharged out of the cathode, and the other remains in the cathode. This increases the wettability of the cathode-gas diffusion layer and the cathode with time. Thus, the DMFC suffers from clogging of pores that constitute a path for feeding oxygen gas. The performance of the cathode varies depending on the amount of oxygen to be fed, and clogging of pores impedes oxygen gas from being fed sufficiently to the cathode, resulting in decreased cell performance.

An operation of DMFC should be conducted in good balance between moisture conditioning (adding) for inhibiting the electrolyte membrane from drying due to evaporation of water, and moisture conditioning (removing) for inhibiting the pores of the cathode from clogging by condensation of cathode product water and electrolyte membrane-permeated water.

To avoid decrease in output due to the cathode product water and electrolyte membrane-permeated water, the cathode product water and electrolyte membrane-permeated water should be discharged more satisfactorily. As a possible solution to discharge these waters more satisfactorily, there are techniques of imparting a moisture conditioning component to the vicinity of the membrane-electrode assembly and/or the gas diffusion layer. Typically, JP-A No. H10-334922 discloses a technique of using a catalyst layer containing a water-retaining agent composed of sulfuric acid or phosphoric acid. JP-A No. 2002-289200 and JP-A No. 2002-270199 each disclose a technique of introducing a metal oxide or zeolite to the electrode and to the vicinity thereof. JP-A No. 2000-251910 and JP-A No. 2001-15137 each disclose a configuration in which a sheet-like water-absorbing material covers an electroconductive plate disposed outside of the electrode, in which the water-absorbing material is composed typically of a nylon(polyamide), cotton, a polyester/rayon, a polyester/acrylic polymer, or a rayon/polychlal.

For moisture conditioning at the interface between an electrolyte and a catalyst layer in a membrane-electrode assembly, JP-A No. 2005-85757 discloses a technique of providing a hydrophilic moisture-retaining layer called “condensation layer” between the electrolyte membrane and the catalyst layer so as to prevent the electrolyte membrane from drying.

### SUMMARY OF THE INVENTION

To develop fuel cells for mobile devices, the present inventors made intensive investigations about how to discharge cathode product water and electrolyte membrane-permeated water that remain or accumulate in the electrode more efficiently so as to improve cell performance. As a result, they found that, among such waters, cathode product water and electrolyte membrane-permeated water occurring in the vicinity of the interface between the cathode and the electrolyte membrane are particularly hard to discharge.

These waters are hard to discharge probably for the following reasons (1) to (3):
(1) the density of the cathode is high for permeating the water;
(2) the cathode contains a hydrophilic proton-conductive resin as a binder; and
(3) one side of the cathode in contact with the gas diffusion layer is affected by air streams flowing outside of the gas diffusion layer, but the other side in contact with the electrolyte membrane is not substantially affected by air streams.

Probably for these reasons, the cathode product water and electrolyte membrane-permeated water occurring in the vicinity of the interface between the cathode and the electrolyte membrane are particularly hard to discharge, whereby the catalyst layer of the cathode in the vicinity of the electrolyte membrane is covered by water. The water clogs pores of the catalyst layer of the cathode, whereby a reaction gas may be insufficiently fed to a side of the catalyst layer of the cathode near to the electrolyte membrane, and the catalyst in this region may not function sufficiently. Improvements in diffusion behaviors of the water and reaction gas in the vicinity of the interface between the cathode and the electrolyte membrane, where water is particularly hard to discharge, are important to discharge the product water efficiently to thereby exhibit high cell performance.

Accordingly, an object of the present invention is to provide a membrane-electrode assembly for use in a fuel cell, and a direct methanol fuel cell, each of which functions to effectively eliminate cathode product water and electrolyte membrane-permeated water remaining or accumulating in the vicinity of the interface between the cathode and the electrolyte membrane, and to feed a reaction gas sufficiently to the vicinity of the interface between the cathode and the electrolyte membrane, and exhibits high performance stably over a long period of time.

According to an embodiment of the present invention, there is provided a diffusion enhancing layer between an electrolyte membrane and a cathode of a membrane-electrode assembly in a direct methanol fuel cell. In a preferred embodiment, the diffusion enhancing layer is composed of a porous member including a water-repellent resin and a proton-conductive resin member. Specifically, the diffusion enhancing layer uses a porous member composed of a water-repellent resin and thereby inhibits water vapor produced as a result of the reaction of Formula (2) in the cathode and water vapor permeating the electrolyte membrane from condensing in the vicinity of the cathode and/or of the electrolyte membrane. The diffusion enhancing layer also uses a proton-conductive resin member, and this facilitates the migration of protons between the electrolyte membrane and the cathode.

Specifically, according to an embodiment of the present invention, there is provided a membrane-electrode assembly which includes an anode; a cathode; and a proton-conductive polymer electrolyte membrane disposed between the anode and the cathode, in which the membrane-electrode assembly further includes a diffusion enhancing layer disposed between the cathode and the proton-conductive polymer electrolyte membrane.

According to another embodiment, there is provided a membrane-electrode assembly structure which includes a membrane-electrode assembly including an anode, a cathode, and a proton-conductive polymer electrolyte membrane disposed between the anode and the cathode; an anode-gas diffusion layer disposed adjacent to the anode; and a cathode-gas diffusion layer disposed adjacent to the cathode in which the membrane-electrode assembly structure further includes a diffusion enhancing layer disposed between the cathode and the proton-conductive polymer electrolyte membrane.

According to still another embodiment, there is provided a membrane-electrode assembly structure which includes a membrane-electrode assembly including an anode, a cathode, and a proton-conductive polymer electrolyte membrane disposed between the anode and the cathode; an anode-gas diffusion layer integrated in one unit with the anode; and a cathode-gas diffusion layer integrated in one unit with the cathode, in which the membrane-electrode assembly structure further includes a diffusion enhancing layer disposed between the cathode and the proton-conductive polymer electrolyte membrane.

According to yet another embodiment, there is provided a direct methanol fuel cell which includes an anode; a cathode; a proton-conductive polymer electrolyte membrane disposed between the anode and the cathode; an anode-gas diffusion layer disposed adjacent to the anode; and a cathode-gas diffusion layer disposed adjacent to the cathode, in which the direct methanol fuel cell further includes a diffusion enhancing layer disposed between the cathode and the proton-conductive polymer electrolyte membrane.

According to another embodiment, there is provided a direct methanol fuel cell which includes an anode; a cathode; a proton-conductive polymer electrolyte membrane disposed between the anode and the cathode; an anode-gas diffusion layer integrated in one unit with the anode; and a cathode-gas diffusion layer integrated in one unit with the cathode, in which the direct methanol fuel cell further includes a diffusion enhancing layer disposed between the cathode and the proton-conductive polymer electrolyte membrane.

According to embodiments of the present invention, there are provided membrane-electrode assemblies for use in fuel cells, and direct methanol fuel cells, each of which functions to effectively eliminate cathode product water and electrolyte membrane-permeated water remaining or accumulating in the vicinity of the interface between the cathode and the electrolyte membrane, whereby feeds a reaction gas sufficiently to the vicinity of the interface between the cathode and the electrolyte membrane, and exhibits high performance stably over a long period of time.

Further objects, features and advantages of the present invention will become apparent from the following description of the preferred embodiments with reference to the attached drawings.

### BRIEF DESCRIPTION OF THE DRAWINGS

FIG. 1 is a schematic diagram which illustrates a cross section of a diffusion enhancing layer for use in an embodiment of the present invention;

FIG. 2 is a separated perspective view which illustrates how a membrane-electrode assembly according to an embodiment of the present invention is prepared;

FIG. 3 is a schematic diagram which illustrates a configuration of a fuel cell according to an embodiment of the present invention; and

FIG. 4 is a graph which illustrates cell characteristics of fuel cells of Example 1 according to an embodiment of the present invention, and of Comparative Example.

### DESCRIPTION OF THE PREFERRED EMBODIMENTS

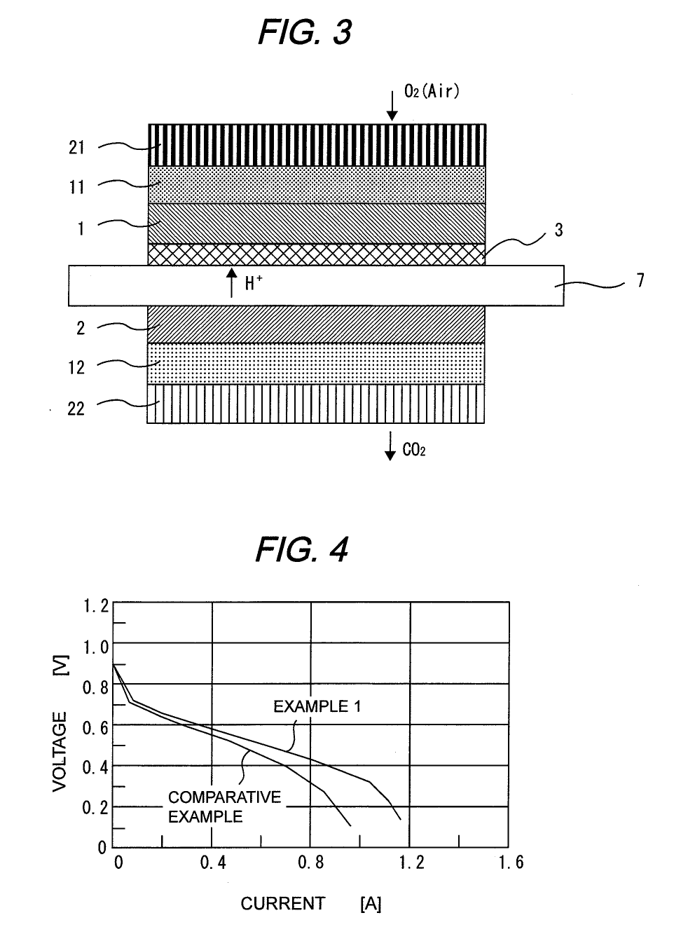

Preferred embodiments of the present invention will be illustrated with reference to the attached drawings. All numbers are herein assumed to be modified by the term “about.” FIG. 3 illustrates a configuration of a direct methanol fuel cell according to an embodiment of the present invention. The direct methanol fuel cell includes a membrane-electrode assembly according to an embodiment of the present invention. The membrane-electrode assembly includes an electrolyte membrane 7; an anode 2 disposed adjacent to one side of the electrolyte membrane 7; a diffusion enhancing layer 3 disposed lo adjacent to the other side of the electrolyte membrane 7; and a cathode 1 disposed adjacent to the diffusion enhancing layer 3. The direct methanol fuel cell further includes a cathode-gas diffusion layer 11 and an anode-gas diffusion layer 12 disposed adjacent to the cathode 1 and the anode 2, respectively.

The diffusion enhancing layer 3 includes a porous member composed of a water-repellent resin matrix and a proton-conductive resin member 6. Specifically, the diffusion enhancing layer uses a porous water-repellent resin member and thereby prevents water vapor produced as a result of the reaction of Formula (2) and water vapor permeating the electrolyte membrane from condensing in the vicinity of the cathode 1 and/or the electrolyte membrane 7. Additionally, the diffusion enhancing layer 3 uses the proton-conductive resin member 6 and thereby enhances migration of protons between the electrolyte membrane 7 and the cathode 1.

As is described above, the fuel cell includes the membrane-electrode assembly including the cathode 1, diffusion enhancing layer 3, electrolyte membrane 7, and anode 2; the anode-gas diffusion layer 12 disposed adjacent to one side of the membrane-electrode assembly; and the cathode-gas diffusion layer 11 disposed adjacent to the other side thereof. The fuel cell further includes an anode-separator 22 and a cathode-separator 21 disposed adjacent to the anode-gas diffusion layer 12 and cathode-gas diffusion layer 11, respectively. Oxygen gas is provide through the cathode-separator 21, and carbon dioxide gas is discharged through the anode-separator 22. Hydrogen ion is transferred from the anode 2 to the cathode 1 through the electrolyte membrane 7.

When the cathode-gas diffusion layer 11 and/or the anode-gas diffusion layer 12 is disposed adjacent to the cathode 1 and/or the anode 2, the two components may be molded and integrated in one unit through the medium of a porous layer made typically of carbon. Such an integrated component is hereinafter referred to as cathode-gas diffusion electrode or anode-gas diffusion electrode.

The electrolyte membrane 7 is composed typically of a sheet-like member of perfluorocarbonsulfonic acid resin.

A material for the catalyst in the anode 2 constituting a power generation unit includes a carbonaceous powdery carrier carrying finely dispersed particles of platinum and ruthenium, respectively, or finely dispersed particles of an platinum-ruthenium alloy. A material for the catalyst in the cathode 1 includes a carbonaceous powdery carrier carrying finely dispersed particles of platinum. These materials for the catalysts are preferred for their easy availability. However, the catalysts in the anode and cathode are not particularly limited, as long as they are used for regular direct methanol fuel cells, and the above-mentioned catalysts may further contain, in addition to the noble metal components, one or more additional components selected typically from iron, tin, and rare earth elements.

Representative properties which the diffusion enhancing layer should have are following properties (1) to (5):
(1) proton conductivity to feed protons produced in the anode via the electrolyte membrane toward the cathode;
(2) water repellency to prevent water permeating from the anode side of the electrolyte membrane from penetrating the cathode;
(3) water repellency to discharge cathode product water out of the electrolyte membrane side of the cathode;
(4) gas permeability to intake air streams diffused in the cathode into the diffusion enhancing layer; and
(5) gas permeability to discharge the cathode product water out of the electrolyte membrane side of the cathode by the action of the air streams diffused from the cathode as described in (4).

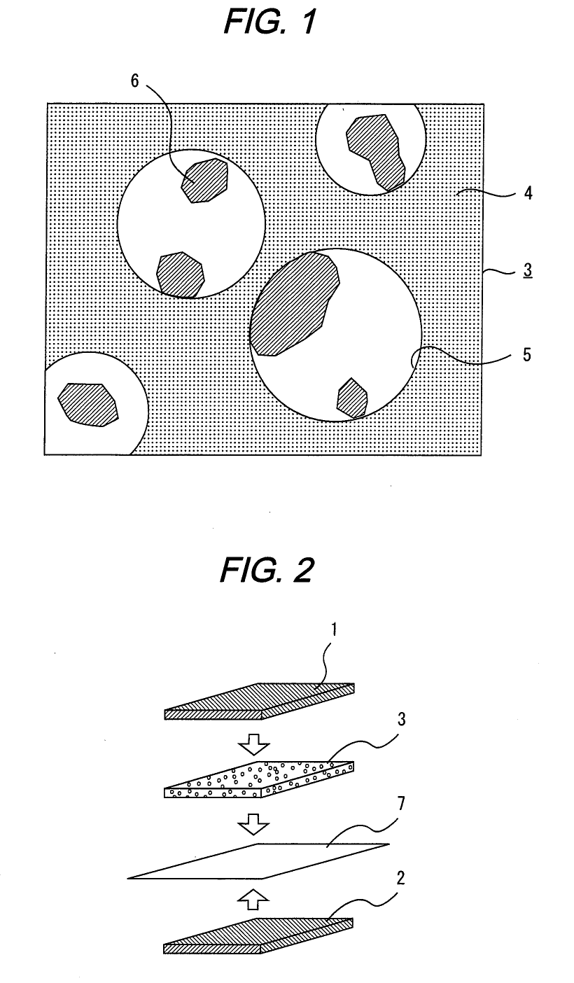

The diffusion enhancing layer is provided herein to exhibit the above properties. In an embodiment, the diffusion enhancing layer includes a water-repellent porous material and, in addition, has proton conductivity. Specifically, the diffusion enhancing layer may be a porous article composed of a water-repellent material and including a proton-conductive resin member. The detail of the diffusion enhancing layer will be illustrated with reference to FIG. 1. FIG. 1 schematically illustrates a cross section of the diffusion enhancing layer. A proton-conductive resin member 6 is arranged in pores 5 of a water-repellent resin matrix 4. The proton-conductive resin member 6 is preferably dispersed in particle form in the pores 5 of the water-repellent resin matrix 4. This renders the surface area of the water-repellent resin matrix 4 larger so as to exhibit water repellency more satisfactorily.

To exhibit the properties (1) to (5), suitable selection should be done typically on materials for constituting the proton-conductive resin member 6, water-repellent materials for constituting the water-repellent resin matrix 4, amounts of these materials; as well as on pore diameter, porosity, gas permeability, and thickness of the diffusion enhancing layer.

The process for the preparation of the diffusion enhancing layer includes, but is not limited to, a process of impregnating a suitable matrix having desired porosity and thickness with a water-repellent material and a proton-conductive resin member 6. For simplifying the preparation process, a porous water-repellent resin matrix 4 previously prepared from a water-repellent material is preferably used as the matrix having desired porosity and thickness. Typically, the diffusion enhancing layer may be prepared by impregnating a porous article of a fluororesin with a dispersion of perfluorocarbonsulfonic acid resin, followed by drying.

Materials for the porous water-repellent resin matrix 4 are not particularly limited, as long as they are water repellent, and include polyethylenes, polypropylenes, polycarbonates; as well as nylons(polyamides), phenolic resins, and acrylic resins. Among them, preferred are porous articles of fluororesins such as polytetrafluoroethylene (hereinafter abbreviated as PTFE), and tetrafluoroethylene-perfluoroalkoxyethylene copolymer (PFA), because they are resistant to heat and soil.

Representative materials for the proton-conductive resin member 6 include sulfonated or alkyl-sulfonated fluoropolymers and polystyrenes, typified by perfluorocarbonsulfonic acid resins and polyperfluorostyrenesulfonic acid resins; as well as poly(ether sulfone)s, poly(ether ether sulfone)s, poly(ether ether ketone)s, and sulfonated hydrocarbon polymers.

The diffusion enhancing layer is arranged between the electrolyte membrane and the cathode, whereby the amount of the proton-conductive resin member affects the resistance of the membrane-electrode assembly. The amount of the proton-conductive resin member is preferably 30 to 50 percent by volume based on the volume of the diffusion enhancing layer. A proton-conductive resin member contained in an amount less than 30 percent by volume may not sufficiently contribute to the migration of protons from the electrolyte membrane to the cathode. A proton-conductive resin member contained in an amount more than 50 percent by volume may excessively increase the hydrophilicity of the diffusion enhancing layer due to high hydrophilicity of the proton-conductive resin member, and this may lead to condensation of water vapor to impede gas diffusion and lead to accumulation of condensed water to impede water discharge. Accordingly, the amount of the proton-conductive resin member is preferably 30 to 50 percent by volume, whereby protons fed from the electrolyte membrane is sufficiently fed to the cathode to allow the reaction of Formula (2) to proceed immediately.

Distribution of pores should be controlled to enhance discharging of water from the vicinity of the cathode. The distribution of pores in the diffusion enhancing layer may be measured according to a known procedure such as mercury porosimetry. The average pore diameter as measured is preferably in the range from 0.060 micrometer to 2.0 micrometers. Pores having an excessively small average pore diameter of less than 0.060 micrometer may cause reduced gas permeability. In contrast, pores having an excessively large average pore diameter of more than 2.0 micrometer may cause accumulation of condensed water droplets in such large pores, although the gas permeability increases. Specifically, in pores having an average pore diameter of 2.0 micrometers or less, water can only undergo capillary condensation. In this case, the diffusion enhancing layer is composed of a water-repellent substrate, whereby the capillary condensation is inhibited in the pores in the diffusion enhancing layer. However, pores having an average pore diameter of more than 2.0 micrometers may induce condensation of water vapor into water droplets at the center part of such large pores, and the condensed droplets clog the pores to reduce the gas permeability. This may adversely affect the functions of the diffusion enhancing layer.

As affecting the gas permeability, the porosity of the diffusion enhancing layer is preferably from 20% to 40%. The diffusion enhancing layer, if having a porosity of 20% to 40%, rapidly diffuses watervapor accompaniedwith gas streams toward the cathode, which water vapor has been discharged from the electrolyte membrane accompanied with protons. A diffusion enhancing layer having a porosity of less than 20% may adversely affect the gas diffusion. A diffusion enhancing layer having a porosity of more than 40% may deform by pressurization during the preparation of the membrane-electrode assembly, and this may cause direct contact between the electrolyte membrane and the cathode.

The diffusion enhancing layer preferably has a gas permeability higher than that of the cathode. This enables rapid diffusion of water vapor accompanied with gas streams toward the cathode, which water vapor has been discharged from the electrolyte membrane accompanied with protons. This in turn prevents water from clogging pores in the cathode layer and from impeding the electrode reactions. The gas permeability of the cathode is, while varying depending on the preparation process of the cathode, on the order of about 30 cm³/(m².24 hr.atm), under conditions at a temperature of 23° C. and relative humidity of 0% in an oxygen atmosphere. The gas permeability of the diffusion enhancing layer is preferably 20000 cm³(m².24 hr.atm) or more under conditions at a temperature of 23° C. and relative humidity of 0% in an oxygen atmosphere. A diffusion enhancing layer having a gas permeability less than that of the cathode may not sufficiently feed oxygen to the cathode.

The thickness of the diffusion enhancing layer is preferably 15 micrometers or more and 200 micrometers or less. A diffusion enhancing layer having a thickness of less than 15 micrometers may have an excessively small space for pores, and such pores in small space may not sufficiently intake water from the electrolyte membrane and/or cathode, and the diffusion enhancing layer may not sufficiently function to discharge water. A diffusion enhancing layer having an excessively large thickness of more than 200 micrometers may have an excessively high electric resistance to increase internal resistance of the membrane-electrode assembly to thereby reduce the output of the fuel cell. The thickness of the diffusion enhancing layer is more preferably 15 micrometers or more and 40 micrometers or less.

Additionally, the use of the diffusion enhancing layer according to this embodiment reduces methanol crossover. In a fuel cell having no diffusion enhancing layer, methanol fed from a fuel tank sequentially permeates the anode, electrolyte membrane, and cathode. In contrast, the diffusion enhancing layer, if contained in a fuel cell, inhibits the permeation of methanol from the electrolyte membrane to the cathode. In a preferred embodiment, the diffusion enhancing layer further contains a catalytic metal capable of decomposing methanol, such as platinum or palladium, and thereby further reduces the methanol crossover.

The present invention will be illustrated in further detail with reference to several examples and comparative example below. It should be noted, however, these are illustrated only by way of example and never construed to limit the scope of the present invention.

### EXAMPLE 1

A membrane-electrode assembly according to an embodiment of the present invention was prepared herein.

A cathode was prepared in the following manner. A catalyst powder was mixed with a water-alcohol mixture solvent (1:2:2 (by weight) mixture of water, isopropanol, and n-propanol) containing perfluorocarbonsulfonic acid (trade name: Nafion™, DuPont) as a binder to give a slurry. The catalyst powder was a carbon carrier carrying 30 percent by weight of fine particles of a 1:1 (atomic ratio) platinum-ruthenium alloy. The slurry was applied to a PTFE film by screen printing to give a porous membrane about 25 micrometers thick.

An anode was prepared in the following manner. A catalyst powder was mixed with a water-alcohol mixture solvent (1:2:2 (by weight) mixture of water, isopropanol, and n-propanol) containing perfluorocarbonsulfonic acid (trade name: Nafion™, DuPont) as a binder to give a slurry. The catalyst powder was a carbon carrier carrying 50 percent by weight of fine particles of a 1:1 (atomic ratio) platinum-ruthenium alloy. The slurry was applied to a PTFE film by screen printing to give a porous membrane about 20 micrometers thick.

The prepared cathode porous membrane and anode porous membrane were cut to pierces each 10 millimeters wide and 20 millimeters long to give a cathode and an anode, respectively.

A diffusion enhancing layer was prepared in the following manner. A porous resin sheet (trade name: NTF1033, Nitto Denko Co., Ltd.) was impregnated with a water-alcohol mixture (1:2:2 (by weight) mixture of water, isopropanol, and n-propanol) containing 2 percent by weight of perfluorocarbonsulfonic acid (trade name: Nafion™, DuPont) electrolyte as a binder, followed by drying at 80° C. for one hour. The prepared diffusion enhancing layer had a thickness of 15 micrometers, and the amount of the impregnated perfluorocarbonsulfonic acid electrolyte was 50 percent by volume relative to the porous resin sheet. The pore distribution of the diffusion enhancing layer was determined by mercury porosimetry to find that the diffusion enhancing layer has an average pore diameter of 1.0 micrometer and a porosity of 36%. This diffusion enhancing layer has a gas permeability of 20,000 cm³/(m².24 hr.atm).

About 0.5 milliliter of a 5 percent by weight solution of Nafion™ in a mixture of water and alcohol (1:2:2 (by weight) mixture of water, isopropanol, and n-propanol; Fluka Chemika (Sigma-Aldrich Co.)) was allowed to penetrate a side of the anode to be in contact with the electrolyte membrane, and the penetrated side of the anode was attached to the power generation region of the electrolyte membrane, followed by drying at 80° C. for three hours under the application of a load of about 1 kilogram. Next, about 0.5 milliliter of the 5 percent by weight solution of Nafion™ in water-alcohol mixture was allowed to penetrate a side of the cathode to be in contact with the electrolyte membrane. Then, as illustrated in FIG. 2, the diffusion enhancing layer was arranged on the electrolyte membrane, and the cathode was arranged thereon so as to overlay the anode with the interposition of the electrolyte membrane, followed by drying at 80° C. for three hours under the application of a load of about 1 kilogram. Thus, a membrane-electrode assembly was prepared.

Using the prepared membrane-electrode assembly, a fuel cell as shown in FIG. 3 was constructed and was subjected to a test for determining current-voltage characteristics. In the determination, the anode and cathode sides of the membrane-electrode assembly were sandwiched between two plies of a carbon paper (Toray Industries, Inc., TGP-H-090) as a gas diffusion layer. The carbon paper had been impregnated with an aqueous dispersion of PTFE fine particles (Polyflon™ Dispersion D-1, Daikin Industries, Ltd.) as a water-repellent material and fired at 340° C. for three hours to carry 5% by weight of PTFE.

During the test, a 10 percent by weight aqueous methanol solution was fed to the anode at a flow rate of 6 cm³ per minute with a microtube pump, and the cathode was left in natural aspiration. The ambient was at a temperature of about 30° C. and relative humidity of about 40%. The result is shown in FIG. 4. The test result demonstrates that the cell gives a high voltage of 0.4 V or more at a current of 0.8 ampere, in terms of current density of 0.4 ampere per square centimeter, and the membrane-electrode assembly shows sufficient performance for use in a direct methanol fuel cell.

### COMPARATIVE EXAMPLE

A common membrane-electrode assembly was prepared according to a known technique.

An anode porous membrane and a cathode porous membrane were prepared each as a porous membrane about 20 micrometers thick on a PTFE film by the procedure of Example 1. The anode porous membrane and cathode porous membrane were cut to pierces each 10 millimeters wide and 20 millimeters long to give an anode and a cathode, respectively.

About 0.5 milliliter of a 5 percent by weight solution of Nafion™ in a mixture of water and alcohol (1:2:2 (by weight) mixture of water, isopropanol, and n-propanol; Fluka Chemika (Sigma-Aldrich Co.)) was allowed to penetrate a side of the anode to be in contact with the electrolyte membrane, and the penetrated side of the anode was attached to the power generation region of the electrolyte membrane, followed by drying at 80° C. for three hours under the application of a load of about 1 kilogram. Next, about 0.5 milliliter of the 5 percent by weight solution of Nafion™ in water-alcohol mixture was allowed to penetrate a side of the cathode to be in contact with the electrolyte membrane. Next, the cathode was arranged adjacent to the electrolyte membrane so as to overlay the anode with the interposition of the electrolyte membrane, followed by drying at 80° C. for three hours under the application of a load of about 1 kilogram. Thus, a membrane-electrode assembly was prepared.

Using the prepared membrane-electrode assembly, a fuel cell as shown in FIG. 3 was constructed and was subjected to a test for determining current-voltage characteristics. During the test, a 10 percent by weight aqueous methanol solution was fed to the anode at a flow rate of 6 cm³ per minute with a microtube pump, and the cathode was left in natural aspiration. The ambient was at a temperature of about 30° C. and relative humidity of about 40%. The test result is shown in FIG. 4. The result demonstrates that the cell gives a voltage of 0.3 V or more at a current of 0.8 ampere, in terms of current density of 0.4 ampere per square centimeter, which voltage is lower than that of Example 1.

FIG. 4 demonstrates that the membrane-electrode assembly of Example 1 according to an embodiment of the present invention shows a higher voltage and higher output at high currents than the membrane-electrode assembly of Comparative Example. At such high currents, the gas diffusion ability and water discharge ability affect the performance of cell. Specifically, the results demonstrate that the membrane-electrode assembly of Example 1 according to an embodiment of the present invention has improved gas diffusion ability and water discharge ability.

### EXAMPLE 2

A membrane-electrode assembly structure as another embodiment of the present invention was prepared in the following manner.

Gas diffusion electrodes used in this embodiment are constructed by forming an anode catalyst layer and a cathode catalyst layer respectively on gas diffusion layers to give an anode integrated in one unit with a gas diffusion layer, and a cathode integrated in one unit with another gas diffusion layer.

A carbon paper (Toray Industries, Inc., TGP-H-090) as a gas diffusion layer had been impregnated with an aqueous dispersion of PTFE fine particles (Polyflon™ Dispersion D-1, Daikin Industries, Ltd.) as a water-repellent material and fired at 340° C. for three hours to carry 5% by weight of PTFE.

If a slurry containing a catalyst and a binder for the formation of an electrode (cathode or anode) is directly sprayed to a side of the carbon paper, pores of the carbon paper may be somewhat filled with the catalyst and binder in the slurry. This may reduce the diffusion abilities of gas and fuel and thereby reduce the output in an operation at a high current density. Accordingly, when to be operated at a high current density, the following treatment was conducted to avoid clogging of pores in the carbon paper.

Specifically, an aqueous dispersion of PTFE fine particles (Polyflon™ Dispersion D-1, Daikin Industries, Ltd.) as a water-repellent material was added to a carbon powder in such an amount as to give a weight after firing of 40 percent by weight, followed by kneading to yield a paste. The paste was applied to one side of the carbon paper by blade coating to a thickness of about 20 micrometers, dried at room temperature, fired at 270° C. for three hours, and thereby yielded a carbon sheet. The sheet was cut to pieces having the same size with the electrodes of the membrane-electrode assembly to give gas diffusion layers.

Next, an anode-gas diffusion electrode was prepared in the following manner. A catalyst powder was mixed with a water-alcohol mixture solvent (1:2:2 (by weight) mixture of water, isopropanol, and n-propanol) containing perfluorocarbonsulfonic acid (trade name: Nafion™, DuPont) as a binder to give a slurry. The catalyst powder was a carbon carrier carrying 50 percent by weight of fine particles of a 1:1 (atomic ratio) platinum-ruthenium alloy. The slurry was applied to the carbon paper as the gas diffusion layer by spraying to form an electrode as an anode.

A cathode-gas diffusion electrode was prepared in the following manner. A catalyst powder was mixed with a water-alcohol mixture solvent (1:2:2 (by weight) mixture of water, isopropanol, and n-propanol) containing perfluorocarbonsulfonic acid (trade name: Nafion™, DuPont) as a binder to give a slurry. The catalyst powder was a carbon carrier carrying 30 percent by weight of fine particles of a 1:1 (atomic ratio) platinum-ruthenium alloy. The slurry was applied to the carbon paper as the gas diffusion layer by spraying to form an electrode as a cathode.

The prepared anode- and cathode-gas diffusion electrodes were respectively cut into pieces 10 millimeters wide and 20 millimeters long.

A diffusion enhancing layer was prepared by the procedure of Example 1. The prepared diffusion enhancing layer had a thickness of 15 micrometers, and the amount of the impregnated perfluorocarbonsulfonic acid electrolyte was 50 percent by volume relative to the porous resin sheet. The pore distribution of the diffusion enhancing layer was determined by mercury porosimetry to find that the diffusion enhancing layer has an average pore diameter of 1.0 micrometer and a porosity of 36%. This diffusion enhancing layer has a gas permeability of 20,000 cm³/((m².24 hr.atm)).

About 0.5 milliliter of a 5 percent by weight solution of Nafion™ in a mixture of water and alcohol (1:2:2 (by weight) mixture of water, isopropanol, and n-propanol; Fluka Chemika (Sigma-Aldrich Co.)) was allowed to penetrate a side of the anode-gas diffusion electrode to be in contact with the electrolyte membrane, and the penetrated side of the anode was attached to the power generation region of the electrolyte membrane, followed by drying at 80° C. for three hours under the application of a load of about 1 kilogram. Next, about 0.5 milliliter of the 5 percent by weight solution of Nafion™ in water-alcohol mixture was allowed to penetrate a side of the cathode-gas diffusion electrode to be in contact with the electrolyte membrane. Then the diffusion enhancing layer was arranged on the electrolyte membrane, and the cathode-gas diffusion electrode was arranged thereon so as to overlay the anode-gas diffusion electrode with the interposition of the electrolyte membrane, followed by drying at 80° C. for three hours under the application of a load of about 1 kilogram. Thus, a membrane-electrode assembly structure was prepared.

A fuel cell was constructed using the prepared membrane-electrode assembly structure including the gas diffusion electrodes and was subjected to a test for the determination of current-voltage characteristics.

During the test, a 10 percent by weight aqueous methanol solution was fed to the anode at a flow rate of 6 cm³ per minute with a microtube pump, and the cathode was left in natural aspiration; and the ambient was at a temperature of about 30° C. and relative humidity of about 40%, as in Example 1 and Comparative Example.

As a result, the fuel cell according to Example 2 gave a high voltage of 0.4 V or more at a current of 0.8 ampere, in terms of current density of 0.4 ampere per square centimeter, to find that the membrane-electrode assembly structure exhibits sufficient performance for use in a direct methanol fuel cell, as in Example 1.

The fuel cell of Example 1 uses a membrane-electrode assembly prepared by impregnating a porous resin sheet with a perfluorocarbonsulfonic acid electrolyte to give a diffusion enhancing layer, and arranging the diffusion enhancing layer on a side of a cathode to be in contact with the electrolyte membrane. The fuel cell of Example 2 uses a membrane-electrode assembly structure prepared by impregnating a porous resin sheet with a perfluorocarbonsulfonic acid electrolyte to give a diffusion enhancing layer, and arranging the diffusion enhancing layer on a side of a cathode-gas diffusion electrode to be in contact with the electrolyte membrane. These fuel cells thereby give high voltages of 0.4 V or more at a current density of 0.4 ampere per square centimeter. The results demonstrate that the membrane-electrode assembly and the membrane-electrode assembly structure have sufficient performance for use in direct methanol fuel cells.

As is described above, the membrane-electrode assemblies and direct methanol fuel cells according to embodiments of the present invention are usable in mobile devices such as notebook personal computers and mobile phones, and in power sources for emergency upon disasters.

What is claimed is:

1. A membrane-electrode assembly comprising:
an anode;
a cathode; and
a proton-conductive polymer electrolyte membrane disposed between the anode and the cathode,
wherein the membrane-electrode assembly further comprises a diffusion enhancing layer disposed between the cathode and the proton-conductive polymer electrolyte membrane.

2. A membrane-electrode assembly structure comprising:
a membrane-electrode assembly including:
an anode,
a cathode, and
a proton-conductive polymer electrolyte membrane disposed between the anode and the cathode;
an anode-gas diffusion layer disposed adjacent to the anode; and
a cathode-gas diffusion layer disposed adjacent to the cathode,
wherein the membrane-electrode assembly structure further comprises a diffusion enhancing layer disposed between the cathode and the proton-conductive polymer electrolyte membrane.

3. A membrane-electrode assembly structure comprising:
a membrane-electrode assembly including:
an anode,
a cathode, and
a proton-conductive polymer electrolyte membrane disposed between the anode and the cathode;
an anode-gas diffusion layer integrated in one unit with the anode; and
a cathode-gas diffusion layer integrated in one unit with the cathode,
wherein the membrane-electrode assembly structure further comprises a diffusion enhancing layer disposed between the cathode and the proton-conductive polymer electrolyte membrane.

4. The membrane-electrode assembly according to claim 1, wherein the diffusion enhancing layer comprises:
a water-repellent resin; and
a proton-conductive resin.

5. The membrane-electrode assembly according to claim 1, wherein the diffusion enhancing layer comprises:
a porous matrix;
a water-repellent material; and
a proton-conductive resin.

6. The membrane-electrode assembly according to claim 1, wherein the diffusion enhancing layer includes pores having an average pore diameter of 0.060 micrometer to 2.0 micrometers.

7. The membrane-electrode assembly according to claim 1, wherein the diffusion enhancing layer has a thickness of 15 micrometers or more and 200 micrometers or less.

8. The membrane-electrode assembly according to claim 1, wherein the diffusion enhancing layer contains 30 to 50 percent by volume of the proton-conductive resin based on the total volume of the diffusion enhancing layer.

9. A direct methanol fuel cell comprising:
an anode;
a cathode;
a proton-conductive polymer electrolyte membrane disposed between the anode and the cathode;
an anode-gas diffusion layer disposed adjacent to the anode; and
a cathode-gas diffusion layer disposed adjacent to the cathode,
wherein the direct methanol fuel cell further comprises a diffusion enhancing layer disposed between the cathode and the proton-conductive polymer electrolyte membrane.

10. A direct methanol fuel cell comprising:
an anode;
a cathode;
a proton-conductive polymer electrolyte membrane disposed between the anode and the cathode;
an anode-gas diffusion layer integrated in one unit with the anode; and
a cathode-gas diffusion layer integrated in one unit with the cathode,
wherein the direct methanol fuel cell further comprises a diffusion enhancing layer disposed between the cathode and the proton-conductive polymer electrolyte membrane.

11. The direct methanol fuel cell according to claim 9, wherein the diffusion enhancing layer comprises:
a water-repellent resin; and
a proton-conductive resin.

12. The direct methanol fuel cell according to claim 9, wherein the diffusion enhancing layer comprises:
a porous matrix;
a water-repellent material; and
a proton-conductive resin.

13. The direct methanol fuel cell according to claim 9, wherein the diffusion enhancing layer includes pores having an average pore diameter of 0.060 micrometer to 2.0 micrometers.

14. The direct methanol fuel cell according to claim 9, wherein the diffusion enhancing layer has a thickness of 15 micrometers or more and 200 micrometers or less.

15. The direct methanol fuel cell according to claim 9, wherein the diffusion enhancing layer contains 30 to 50 percent by volume of the proton-conductive resin based on the total volume of the diffusion enhancing layer.
